(19) United States
(12) Patent Application Publication
(10) Pub. No.: US 2026/0183797 A1
(43) Pub. Date: Jul. 2, 2026

(54) SIEVE DEVICE FOR PLANSIFTERS FOR FRACTIONATING GROUND CEREAL PRODUCTS

(71) Applicant: Swisca AG, Appenzell (CH)

(72) Inventors: Oliver Ensslin, Appenzell (CH); Jonas Schär, Appenzell (CH)

(21) Appl. No.: 19/125,419

(22) PCT Filed: Nov. 6, 2023
(86) PCT No.: PCT/EP2023/080859

§ 371 Date: Apr. 29, 2025

(30) Foreign Application Priority Data
Nov. 7, 2022 (CH) CH001320/2022

(51) Int. Cl. B07B 1/38

(52) U.S. Cl. CPC B07B 1/38; B07B 2201/04

(57) ABSTRACT

A sieve device for plansifters includes a sieve frame for a sieve. The sieve device at positions which correspond to one another at the upper side and lower side forms an upper-side and lower-side stack structure respectively. The upper-side and the lower-side stack structure are matched to one another in the sense that on stacking several of the sieve devices, the upper sieve device is defined in its horizontal position relative to the lower sieve device. Herein, the upper-side stack structure include a first ramp and the lower-side stack structure a second ramp, wherein the first ramp and the second ramp are in contact with one another in a force-transmitting manner when a lower and an upper sieve device are stacked onto one another.

### BACKGROUND OF THE INVENTION

### Field of the Invention

The invention relates to machines, for example plansifters, as are applied for fractionating ground cereal products. In particular, it relates to a sieve device for a plansifter.

### Description of Related Art

Plansifters serve for the separation of constituents of a ground product into coarser or finer grained constituents and under certain circumstances also into constituents of different densities, as well as for the removal of foreign bodies from the ground product. The separating of the ground product into differently grained constituents is also denoted as “grading” or “fractionating”. Plansifters are generally used in the milling industry for fractionating ground cereal products between and after passages through the roller mill of a cereal mill. They can also be applied for so-called control sifting, i.e. sieving of flour which per se is ready for sale.

Plansifters include sieve compartments which each include a stack of plane sieves and are brought into horizontally oscillatory movements, in particular into circular oscillations in the sieve plane by way of a suitable drive mechanism. The sieves are each spanned on primary frames, so-called “insert frames” which for their part are inserted in sieve frames (denoted here as “secondary frames”). Seals, for example of a suitable felt are each present on the plane of the sieve mesh between sieve frames which lie on one another and are to prevent the product from exiting laterally in an undesired manner.

Generally, a closed sieve box which guides the sieve frames is present so that the sieve frames lie on one another in a precisely aligned manner. The sieve frames can each be inserted into the sieve box or removed from this, through a door. Such a closed sieve box however has the disadvantage that a part of the present space is used for the walls of the box and its door. Moreover, the removal and insertion of individual sieve frames is only possible in one direction (through the door), and the removal and insertion of sieve frames which are not arranged in the stack at the very top is cumbersome and to some extent not even possible at all without the removal of the sieve frames which lie thereabove.

For this reason, plansifters with open sieve stacks, without boxes have already been suggested. In these, the correct alignment of the sieve frames of the sieve stack needs to be ensured by way of suitable structures, specifically upper-side grooves, into which ribs which are arranged at the lower side on the sieve frame of the sieve device lying thereabove engage: a pin-hole connection is also already known. Such a solution however places high demands on the fitting accuracy, in order for undesirable relative movements between the sieve frames not to be possible during the oscillation movements of the plansifter. Moreover, for the removal and insertion of a sieve device, the sieve device which is to be removed—together with all sieve devices lying thereabove—needs to be lifted over its complete depth by way of a tool, since the groove-rib connection otherwise prevents a horizontal movement. Contamination can also collect in the groove over the course of time.

US 2008/0257791 A1 relates to a stackable sieve frame for sifters. The sieve frame includes side walls which form a labyrinth seal on stacking the sieve frames. For this purpose, the side walls at the upper and lower side include horizontal and oblique surfaces which are matched to one another. The labyrinth seal is also to effect a vertical alignment of the sieve frames relative to one another. For achieving the labyrinth seal effect, the angles between the horizontal and oblique surfaces must be comparatively large, specifically be close to 90°.

### SUMMARY OF THE INVENTION

It is an object of the present invention to provide a sieve device for plansifters—as well as a plansifter—which at least partly provides a remedy. In particular, the sieve device should permit the formation of open sieve stacks without this entailing the disadvantages which have been outlined above.

This object is achieved by the invention as is defined in the patent claims.

According to an aspect of the present invention, a sieve device for plansifters is provided. This sieve device includes a sieve frame for a sieve. The sieve device at the upper side and lower side each forms an upper-side and lower-side stack structure respectively at positions which correspond to one another (the same x-y positions in the coordinate system which is used here and whose z-axis corresponds to the vertical). The upper-side and lower-side stack structure are matched to one another in the sense that on stacking several of the sieve devices, the upper sieve device is defined in its horizontal position relative to the lower sieve device. Herein, the upper-side stack structure includes a first ramp and the lower-side stack structure includes a second ramp, wherein the first and second ramp are in contact with one another in a force-transmitting manner when a lower and an upper sieve device are stacked on one another.

The upper-side and the lower-side stack structure can be formed by the sieve frame. However, it is also possible for regions of another element of the sieve device, for example of the clamping frame described hereinafter, to belong to the stack structure. At all events, in embodiments, the sieve frame forms the lower-side stack structure as well as elements of the upper-side stack structure, so that sieve frames of the stacked sieve devices lie on one another in the stack and the sieve frame extends over the complete height of the sieve device. In particular, an outer wall surface of the stack can be completely formed by outer wall surfaces of the stacked sieve frames.

A ramp in the context of the present text is formed by a surface section which in regions is flat and inclined to the horizontal as well as to the vertical.

A force-transmitting contact of the first and second ramp, amongst other things results in the first and second ramp running parallel to one another, i.e. locally, at positions (x-y-positions) which correspond to one another, having the same inclination angle (identical normal vectors).

By way of the first and the second ramp contacting one another in a force-transmitting manner, the upper sieve device is not only supported with respect to the lower sieve device on which it lies, but is also aligned in its horizontal position and specifically without groove-rib structures which are matched to one another in an exactly fitting manner and which have the aforementioned disadvantages having to be present. Apart from this, there is also an advantage with regard to the sealing effect, in particular in combination with the principle which is yet described hereinafter, of providing the sieve in a manner fastened onto an insert frame, the insert frame being inserted into a trough-like structure of the sieve frame, which is why the ramps which lie on one another are not arranged at the sieve plane, but above this.

In particular therefore, one envisages the insert frame with the sieve being positioned such that the plane of the sieve is arranged below the first ramp and for example also above the second ramp, thus at a central position with respect to the vertical, which is in contrast to the state of the art which envisages the sieve on the sieve frame being at the very top in each case.

In particular, one can envisage the upper sieve device only lying on ramps (oblique surfaces) of the lower sieve device and therefore there being no horizontal surfaces which lie on one another in a force-transmitting manner.

In particular, the first ramp can be descending outwards and the second ramp descending inwards. However, the reverse is also possible, i.e. the first ramp can be descending inwards and the second ramp descending outwards. In particular, it is also possible for these two possibilities to be combined, i.e. the upper-side stack structure can each include an outwardly descending and in inwardly descending ramp, wherein then accordingly the lower-side stack structure includes an inwardly descending and an outwardly descending ramp, which is be dealt with in more detail hereinafter.

It has been found that a further problem can be solved by way of the design of the stack structures with the ramps: the sieve device can be removed from a stack by way of it being slightly lifted at one side and then being pulled in the direction of this side (assuming that there are no sieve devices which lie thereabove and which with their complete weight lie on the sieve device to be removed), and specifically in a tool-free manner in many embodiments. This is a substantial advantage since sieve stacks are often not so easily accessible from all sides to the same extent and a lifting also at the side which is not accessible (“rear side”) is not that simple without a tool.

In general, in this text, what is meant by stacking on one another and the accordingly formed stack is a designated stacking, concerning which generally the outer contours of the sieve devices which lie on one another are aligned to one another and the respective upper sieve devices lies on the lower sieve device in a stable manner and, on account of the procedure according to the invention, in a play-free manner with respect to horizontal displacements, wherein the sieve generally lies horizontally. The sieve devices which are stacked on one another in particular can have essentially the same outer contours, so that the outer wall surfaces of the stacked sieve devices are flush with one another.

It is particularly favourable if the first ramp and the second ramp have an angle of between 25° and 65° or between 15° and 60°, in particular between 30° and 50°, for example roughly 45° to the horizontal. In this range, the desired, aforedescribed effect is achieved and at the same time the removal by way of lifting at the front side and pulling-out is possible without any problem, which is no longer so easily assured given steeper ramps (angles larger than 50°, 60° or) 65°.

Apart from the first and the second ramp, the upper-side stack structure can also include an upper-side third ramp and the lower-side stack structure a corresponding lower-side fourth ramp, wherein the inclinations of the third and fourth ramp likewise correspond to one another (they can correspond to the inclination of the first and second ramp, but this does not need to be the case). If the first ramp is descending to the outside and the second ramp accordingly descending to the inside, herein the third ramp is descending to the inside and the fourth ramp descending to the outside.

If, as the case may be, the first and third ramp as well as the second ramp and the fourth ramp each belong to the same wall section, then the centring effect of the ramps also acts locally for the pairing of a wall section of the upper sieve device with a wall section of the lower sieve device. This has the effect that the stack structure is also very stable when the walls only have a slight thickness and are accordingly still slightly flexible.

In particular, the first and the second ramp are designed peripherally around the sieve device, i.e. they extend for example in an uninterrupted manner along the complete periphery of the sieve frame or at least along a substantial part thereof. The third and the fourth ramp can also possibly be circumferential.

The sieve device can be of several walls. Moreover, depending on the configuration, one or also two rows of (vertical) through-channels can be present. Through-channels are generally vertical channels which are present laterally on the sieve frame and through which sieving product can fall downwards into a next-lower sieve frame or an outlet conduit. The sieving product which falls through the through-channels gets from these either onto a sieve of the (accordingly differently configured) sieve device lying therebelow or into a through-channel of the sieve device lying therebelow or possibly into an outlet conduit.

In this case, apart from an outer wall surface (which for example merges into the first and second ramp at the upper and lower side respectively) and an inner wall surface (as the case may be possibly with the third and fourth ramp), sections of wall surfaces which surround the through-channels also result. For this reason, several wall sections result in the vertical section through the through-channels. In this case, for example at least the outermost wall section—which also forms the outer wall surface—would include the stack structures of the described type. However, apart from the outermost wall section, in particular it is also possible for wall sections which lie further to the inside and for example all wall sections to each include an upper and a lower stack structure of the described type. Ramps which are matched to one another in particular can be peripheral around the through-channels, i.e. a through-channel wall around the through-channel at the upper side includes a beveling and at the lower side a projection which forms a ramp. For this reason, it is for example also possible for the third ramp of the outermost wall section to run along a contour of a through-channel and to thus continuously merge into the first ramp of the next-inner wall section; analogously for the fourth ramp of the outermost wall section and the second ramp of the next-inner wall section, etc.

In embodiments, the sieve device apart from the sieve frame includes an insert frame, to which the sieve is fastened. The sieve frame in particular can include a peripheral side wall and an—inwardly projecting—rest, on which the insert frame lies, and specifically such that the sieve lies within the peripheral side wall—i.e. the peripheral side wall surrounds the insert frame with the sieve at the outer side, along an outer delimitation (edge or the like) of the insert frame. Furthermore, the sieve can lie below an upper edge of the peripheral side wall, so that the sieve frame quasi forms a trough, in which the insert frame with the sieve lies, for example in a precisely fitting manner, i.e. immovably relative to the sieve frame in the horizontal direction. Amongst other things, this has the advantage that the upper-side stack structure is not arranged on the plane of the sieve, which is why also no sieving product which is under hydrostatic pressure (if in a simplified manner and for this case, the sieving product is considered as a fluid) is pressed against the seal which forms due to the ramps contacting one another. In contrast, at the most, grinding product dust comes into contact with the ramps. It has been found that due to this measure, as well as due to the obliqueness of the ramps, the sealing effect is already sufficient without the stack structures requiring additional sealing means.

The insert frame can be metallic—for example it can be designed as a metallic flat body (thin plate) with at least one large-surfaced recess, over which the sieve is spanned. The insert frame for example can include an outer frame part which as a whole is essentially rectangular, with dimensions which are adapted to the rest. Apart from the outer frame part, a system of at least one rod which in cross section is for example rectangular and over which the sieve is spanned can also be present. The sieve can optionally likewise be metallic. It can be designed as a flat body, in particular as a metal sheet, with the sieve openings as through-holes. The sieve can be welded to the insert frame.

Apart from the sieve frame and the insert frame, the sieve device in embodiments also includes a clamping frame. The clamping frame is arranged such that the insert frame is fixed between the rest and the clamping frame. The clamping frame can fit into the receiver in an exactly fitting manner, said receiver forming within an upper portion (above the rest) of the peripheral side wall of the sieve frame.

In embodiments, the clamping frame can be shaped out such that the inner surface is flush with the inner surface of the lower portion (below the clamping frame) of the peripheral side wall. Supplementarily or alternatively, the clamping frame at the upper side can be flush with the upper edge of the peripheral side wall, i.e. its height can correspond to the height of the upper portion of the peripheral side wall, minus the thickness of the insert frame.

The clamping frame for example can have the shape of a rectangular profile.

The clamping frame can also possibly be metallic, possibly with a thermally insulating filling material.

As the case may be, the clamping frame can form the third ramp or a region (part) thereof by way of it including a beveling at the upper and inner side.

Additionally to the sieve device, the present invention also relates to a plansifter with at least one stack of sieve devices of the type described here, additionally to a drive mechanism which brings this stack into horizontally oscillating movements, for example circular movements.

### BRIEF DESCRIPTION OF THE DRAWINGS

Embodiment examples of the invention are described hereinafter by way of drawings. In the drawings, the same reference numerals denote equal or analogous elements. The drawings show elements which partly correspond to one another in sizes which differ from figure to figure. There are shown in:

FIG. 1: a view of a plansifter with closed sieve compartments;

FIG. 2: a plansifter with open sieve stacks;

FIG. 3: an exploded representation of a sieve device with a sieve, primary frame, clamping frame and insert frame;

FIG. 4: a view of two sectioned sieve devices which are stacked on one another;

FIG. 5 one of the sieve devices of FIG. 4 in a plan view, front elevation and side elevation;

FIG. 6 a detail of FIG. 5 represented in an enlarged manner.

### DETAILED DESCRIPTION OF THE INVENTION

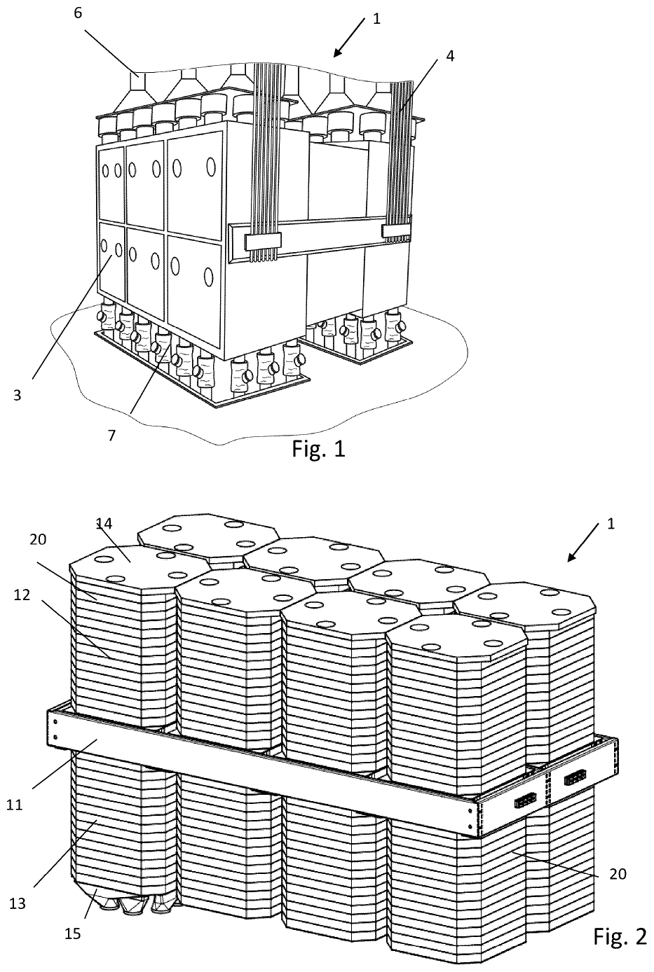

FIG. 1 shows a plansifter 1 as is applied in cereal mills. The plansifter includes a plurality of sieve compartments which via a common suspension device 4 are assembled in a space such that common horizontally oscillating movements are possible. A drive (not visible in FIG. 1) is configured to bring the ensemble of sieve compartments into for example horizontally circling oscillations. Furthermore, the plansifter includes flexible feed conduits 6 as a sieving product inlet, as well as likewise flexible outlet conduits 7 as a sieving product outlet. Each sieve compartment includes a stack of sieve devices which are arranged above one another. In the embodiment of FIG. 1, the sieve compartments are present in sieve boxes 3 which each form a housing for the sieve compartments. In such embodiments, the sieve devices which lie over one another in a stack-like manner are guided by way of suitable structures of the housing.

As an alternative to sieve compartments which are present in sieve boxes 3, sieve compartments can also be formed by open sieve stacks, concerning which a housing which surrounds a sieve stack is done away with.

FIG. 2 shows an embodiment example of such a plansifter with open sieve stacks in a particularly space-saving arrangement, wherein some elements (suspension device, feed conduits, to some extent outlet conduits) are not represented. A mount 11 serves as a mechanical carrier structure. It forms a carrier frame for the upper sieve stacks 12 and the lower sieve stacks 13 and in the represented embodiments also receives the drive modules which are not visible in the figure. The sieve stacks are fastened to the mount 11 in a direct or indirect manner, for example by way of a clamping system of rods and/or straps and/or other means; the clamping system is not represented in FIG. 2.

Drive modules for a modular construction which can be received in a mount 11 of the type which is drawn in FIG. 2 are described in the Swiss patent application 000722/2022. However, the present invention is independent of the design of the plansifter drive and also functions for plansifters with a central drive device as are often to be found and as are present centrally between the sieve boxes 3 as in a plansifter of the type which is drawn in FIG. 1.

The upper sieve stack 12 and the lower sieve stack 2 in FIG. 2 are each formed from a multitude of sieve devices 20 of the type described hereinafter, wherein the sieve devices are stacked on one another in a direct manner and wherein yet a closure element 14 and 15 by way of which element sieving product is fed and discharged is present at the upper side on the upper sieve stack 12 and at the lower side on the lower sieve stack respectively. The sieves can have different mesh widths and the configuration of the sieve stacks can each be selected by the user in accordance with requirements. A plansifter with closed sieve compartments as is represented in FIG. 1 can also include sieve devices 20 according to the subsequent description.

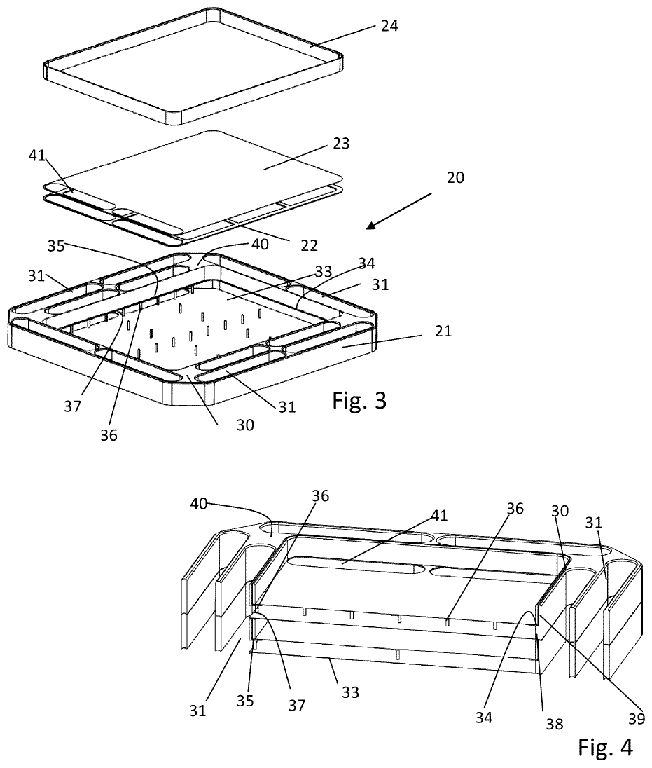

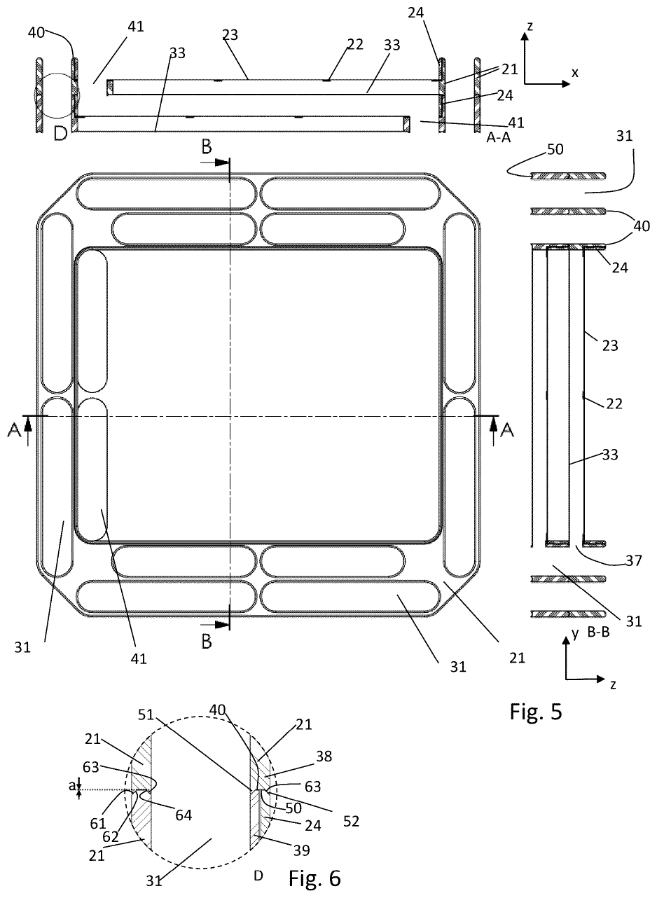

A sieve device 20 is shown in an exploded illustration in FIG. 3. FIG. 4 shows a view of two sectioned sieve devices 20 which are stacked on one another. FIG. 5 shows a view of the sieve devices 20 of FIG. 4 from above as well as sections through the planes A-A and B-B in a view from above, i.e. FIG. 5 shows a plan elevation, front elevation and a lateral elevation of the arrangement of FIG. 4. FIG. 6 shows detail D from the section A-A in FIG. 5.

A sieve frame 21 forms a mechanical carrier structure of the sieve device 20. An insert frame 22 (primary frame) carries the sieve 23. For example, the sieve 23 can be designed as a metallic foil with perforations as sieve holes as is represented in the Swiss patent application 000837/2022, wherein the foil is welded onto the—likewise metallic—insert frame 22

Apart from the sieve frame 21 and the insert frame 22 with the sieve 23 which is fastened thereto, the sieve device also includes a clamping frame 24 which fixedly holds the—flat—insert frame 22 and the sieve 23 relative to the sieve frame 21.

The sieve frame includes a circumferential side wall 30 and in this towards the sides in each case two rows or one row or no row, of at least one through-channel 31, so that the side wall forms wall sections to the very outside, to the very inside and possibly between the through-channels 31. In the drawn embodiment example, two rows each with two through-channels 31 are each present at two opposite sides (in the plan elevation according to FIG. 5 at the top and the bottom), whereas the two other opposite sides each include one row with two through-channels 31. The arrangement of through-channels can vary from sieve device to sieve device, in order to lead fractions of the sieving product which are fed in through the feed conduits as well separated by the sieves, in a designated manner.

Per sieve device, a collection region forms below the sieve 23 and this is closed off to the bottom by a collection base 33 of the sieve frame 21. The collection region in each case is open to at least one side, in order to discharge fine shares of the sieving product which have gotten through the sieve (the so-called throughs) through a laterally arranged slot opening 37 which runs out into a through-channel 31. The collection region is closed to the other sides by a lower portion 38 of the peripheral side wall 30, said side wall being formed by the sieve frame. The other through-channels 31 of the upper sieve device which are represented in the figures serve as drop-channels, i.e. for the continued passage downwards of sieving product which comes from a sieve device which lies further to the top or from a sieving product inlet.

The sieve 23 includes lateral sieve through-openings 41 which are present on the sieve plane and through which sieving product shares which have not been sieved through the sieve (the so-called overflow) can fall.

The sieve frame 21 forms a circumferential rest for the insert frame 22. The rest can be formed by a shoulder 34 where the collection region is closed off to the sides by a lower portion 38 of the circumferential side wall 30, whilst at other locations above the lateral slot opening 37 it can be formed by an inwardly projecting projection 35. The rest is uninterrupted along the peripheral line of the insert frame 22.

In embodiments, the sieve frame is at least partly metallic. In such embodiments, the collection base can be formed by a base sheet and the peripheral side wall can be constructed of several parts, with several wall elements, for example with an outer wall element which forms the outer wall surface, a lower inner wall element which forms the inner wall surface of the lower portion 38, an upper inner wall element which forms the inner wall surface of the upper portion 39 and several through-channel wall elements which surround the through-channels. A thermally insulating filling material can be arranged in the intermediate spaces between the wall elements. The shoulder 34 and the projection 35, i.e. the rest can be formed by an intermediate base.

The dimensions of the sieve frame 21 on the one hand and of the clamping frame 24 on the other hand are matched to one another such that the clamping frame fits precisely into the receiver which results within the upper portion of the circumferential side wall.

Furthermore, the height of the clamping frame 24 is matched to the distance between the rest and the upper edge 40 of the surrounding side wall as well as to the thickness of the insert frame 22, so that the upper edge of the clamping frame 24 lies at the same height as the upper edge 40 of the peripheral side wall, so that the clamping frame 24 on stacking the sieve devices 20 acts and can be perceived as a part of the sieve frame 21.

In particular, in FIG. 6 one can see that the sieve devices 20 include an upper-side stack structure and a lower-side stack structure at horizontal positions (x-y positions) which correspond to one another, see the Cartesian coordinate system which is indicted in the upper and right panel of FIG. 5. If the sieve devices are stacked upon one another in the designated manner, then the lower-side stack structure of the respective upper sieve device lies on the upper-side stack structure of the lower sieve device.

The upper-side stack structure includes an outwardly descending first ramp 61, on which an inwardly descending second ramp 62 of the lower-side stack structure of the upper sieve device 20 lies. The outwardly descending first ramp 61 and the inwardly descending second ramp 62 are plane and parallel to one another in the represented embodiment example. They have an angle of between 25° and 65°, in particular between 30° and 50° to the horizontal.

“Inner” and “outer” are to be understood in relation to the sieve device as a whole, i.e. “inner” is the side of the wall which faces the sieve and the collection region, whereas “outer” is the opposite side, at the left in FIG. 6.

The upper and the lower stack structure are designed such that the first and the second ramp 61, 62 lie on one another in a force-transmitting manner. For this reason, generally no force-transmitting resting takes place upon the upper edge 40—there, the surface of the sieve frame runs horizontally in an extensive manner, in alternative embodiments also in a curved manner. In contrast, a distance a results between the upper edge 40 and the lower-side counter-surface 50, wherein the distance a under certain circumstances—depending on the manufacturing tolerances—can be very small and be 1-2 mm or even less.

In the represented embodiment example, the upper-side stack structure apart from the outwardly descending first ramp 61 also includes an upper-side, inwardly descending third ramp 63 and accordingly the lower-side stack structure includes a lower-side, outwardly descending fourth ramp 64. For this reason, the centring effect of the ramps also acts in a local manner, for each pair of a wall section of the upper sieve device with a wall section of the lower sieve device. The effect of this is that the stack structure is even quite stable when the walls only have a low thickness and accordingly are still slightly flexible.

On account of the through-channels 31, the sieve frames 21 depending on the configuration include several wall sections in the vertical section (sections A-A and B-B in FIG. 5 as well as FIG. 6). In the shown embodiment, two wall sections are each present for example on two sides, and three wall sections are present on the other two sides, corresponding to the two rows of through-channels. Given several wall sections per side, the represented stack structure is present at least at the respective outermost wall, and present for example at each wall. In the represented embodiment example, each wall includes a stack structure of the described type, which one can likewise see in FIG. 5 in the sections A-A and B-B as well as in FIG. 6.

Concerning the innermost wall section, the inwardly descending third ramp 63 is not formed by the sieve frame, but by clamping frame 24 which is shown at the right in FIG. 6.

The inwardly descending second ramp 62 of the lower-side stack structure and possibly its outwardly descending fourth ramp 64 in the represented embodiment example is/are each formed by a downwardly projecting outer and inner rib 51 and 52 respectively of the sieve frame 21, so that the walls of the sieve frame 21 are concave at the lower side. Accordingly, the walls of the sieve frame are convex at the upper side. This has the advantage that residues cannot accumulate in a groove (or other concave upper-side structure) in the course of time. A reverse configuration however is also not to be ruled out—also due to the very good sealing characteristics of the sieve frame. This means that it can also be the case that the outwardly descending first ramp of the upper-side stack structure is formed by an upwardly projecting rib and conversely the walls of the sieve frame are convex on the lower side.

1. A sieve device for a plansifter, comprising a sieve frame for carrying a sieve, wherein the sieve device at positions which correspond to one another at the upper side and lower side comprises an upper side and lower side stack structure respectively, characterised in that the upper-side stack structure comprises a first ramp and the lower-side stack structure a second ramp, said ramps being shaped and arranged such that when the sieve device as a lower sieve device and an identical sieve device as an upper sieve device are stacked on one another, the first ramp of the lower sieve device and the second ramp of the upper sieve device contacting one another in a force-transmitting manner.

2. The sieve device according to claim 1, wherein the upper-side stack structure and the lower-side stack structure are shaped out such that when the sieve device as a lower sieve device and an identical sieve device as an upper sieve device are stacked on one another, the upper sieve device only lies on the ramps of the lower sieve device and that there are no horizontal surfaces which lie on one another in a force-transmitting manner.

3. The sieve device according to claim 1, wherein the first ramp and the second ramp each have an identical angle of between 30° and 50° to the horizontal.

4. The sieve device according to claim 1, comprising an insert frame to which the sieve is fastened, wherein the sieve frame forms a circumferential side wall and comprises an inwardly projecting rest, on which the insert frame lies.

5. The sieve device according to claim 4, wherein the sieve device further comprises a clamping frame which is arranged above the insert frame and within an upper portion of the peripheral side wall.

6. The sieve device according to claim 1, wherein the first ramp is outwardly descending and the second ramp is inwardly descending.

7. The sieve device according to claim 6, wherein the upper-side stack structure further comprises an upper-side, inwardly descending third ramp and the lower-side stack structure a lower-side, outwardly descending fourth ramp, said ramps being shaped and arranged such that when the sieve device as a lower sieve device and an identical sieve device as an upper sieve device are stacked onto one another, the third ramp of the lower sieve device and the fourth ramp of the upper sieve device contacting one another in a force-transmitting manner.

8. The sieve device according to claim 7, wherein wall sections of the sieve frame are concave at the lower side by way of them forming a downwardly projecting outer rib and a downwardly projecting inner rib, wherein the second ramp is formed by the outer rib and the fourth ramp by the inner rib.

9. The sieve device according to or claim 7, comprising the clamping frame, wherein the clamping frame forms at least a part of the third ramp by way of it comprising an inner-side beveling towards its upper edge.

10. The sieve device according to claim 7, wherein the sieve frame forms at least one vertical through-channel, wherein a through-channel wall around the through-channel at the upper side comprises a beveling and at the lower side comprises a projection which forms a ramp, so that along a contour of the through-channel a region of the first ramp continuously merges into a region of the third ramp and a region of the second ramp continuously merges into a region of the fourth ramp.

11. A plansifter for fractionating ground cereal products for a cereal mill, comprising at least one stack with a plurality of sieve devices according to claim 1, as well as a sieving product inlet and a sieving product outlet, wherein the plansifter is further configured to bring the stack into oscillation movements in order to encourage the at least partial passage of sieving product through the sieves of the sieve devices, said sieving product being brought in through the sieving product inlet.
